(19) United States
(12) Patent Application Publication
(10) Pub. No.: US 2006/0091255 A1
(43) Pub. Date: May 4, 2006

(54) Antiballistic missile defense

(76) Inventor: Glen Mark Wakefield, Tempe, AZ (US)

Correspondence Address: Glenn Wakefield, 1416 East Carmen Street, Tempe, AZ, 85283-4142, US

(21) Appl. No.: 11/012,053

(22) Filed: Dec. 14, 2004

Related U.S. Application Data
(60) Provisional application No. 60/535,280, filed on Jan. 10, 2004.

(51) Int. Cl. F41F 5/00; B64D 1/04; F42B 15/10

(52) U.S. Cl. 244/3.1; 89/1.11

(57) ABSTRACT

Multiwavelength satellites, illuminating satellites and multiwavelength antiballistic missiles working in cooperation may overcome enemy missile countermeasures (i.e. decoys, aerosols, changing trajectory). Multiwavelength satellites and multiwavelength antiballistic missiles may be designed to detect and fuse multiple wavelengths. Illuminating satellites may highlight an enemy missile for enhanced detection.

### CROSS-REFERENCE TO RELATED APPLICATIONS

Provisional application No. 60/526,002, filed December 2003.

Provisional application No. 60/535,280, filed January 2004.

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT DISC APPENDIX

Not Applicable

### BACKGROUND OF THE INVENTION

This patent application applies to the field of antiballistic missile defense.

The antiballistic missile defense system is based on a layered defense system (boost, post boost, reentry). In the post boost phase there is little chance of destroying an enemy missile disguised with countermeasures based on the current system (hit-to-kill).

### BRIEF SUMMARY OF THE INVENTION

Multiwavelength satellites, illuminating satellites and multiwavelength antiballistic missiles working in cooperation may overcome enemy missile countermeasures (i.e. decoys, aerosols, changing trajectory). Multiwavelength satellites and multiwavelength antiballistic missiles may be designed to detect and fuse multiple wavelengths. Illuminating satellites may highlight an enemy missile for enhanced detection.

### BRIEF DESCRIPTION OF THE SEVERAL VIEWS OF THE DRAWING

Not Applicable

### DETAILED DESCRIPTION OF THE INVENTION

The antiballistic missile defense system is based on a layered defense system (boost, post boost, reentry). In the post boost phase there is little chance of destroying an enemy missile disguised with countermeasures based on the current system (hit-to-kill). The proposed system is resistant to countermeasures and may track the enemy missile from launch to destination. This robust track provides an increased chance of destroying an enemy missile in any phase.

Multiwavelength satellites, illuminating satellites and multiwavelength antiballistic missiles may overcome enemy missile countermeasures (i.e. decoys, aerosols, changing trajectory). The multiwavelength antiballistic missile may be guided by the multiwavelength satellites, the global positioning system, the internal sensory system and the internal navigation system. The multiwavelength satellite and the multiwavelength antiballistic missile may consist of a main reflector capable of collimating/focusing a wide selection of arbitrary wavelengths (.i.e. multilayered dielectric reflector). The reflector's light may then be directed to a particular wavelength sensor by appropriate means (i.e. moveable dielectric mirror, moveable filters). The enemy missile may be viewed at different wavelengths through time division observation. Condition based wavelength selection/fusion may provide more accurate tracking. Closing range target destruction may be based on lidar and internal sensor systems. A sufficient number of multiwavelength satellites may be deployed to observe and track the enemy missile against the blackness of space. This black background may provide a high resolution view of the missile/countermeasures. Countermeasures may be defeated by computer/human analysis of the unique missile trajectory (fixed post boost), wavelength selection to see through the aerosol, behavioral movement of the decoy disguised missile (i.e. missile inside balloon)/decoys (i.e. balloon) under different illumination conditions and rapid trajectory updates to maintain lock on an evasive missile (i.e. trajectory changes post boost). This multiwavelength satellite track may be difficult to break. This detection scheme may be accomplished with the light of day on the enemy missile; but, the enemy missile is more difficult to discern at night. To improve nighttime performance, a series of illuminating satellites with large optical systems may cover the earth. These illuminating satellites may receive the coordinates of the enemy missile from the multiwavelength satellites. The illuminating satellites may then rotate into position focusing the light (i.e. sun, led, laser) onto the enemy missile/decoys. This allows the multiwavelength satellite to observe the highlighted missile/decoys against the blackness of space. Under these conditions, the multiwavelength satellites may direct the multiwavelength antiballistic missile to the target. The multiwavelength antiballistic missile may also carry high power explosives, an electromagnetic pulse weapon or a nuclear weapon to ensure destruction or to take out multiple missiles/decoys. The multiwavelength antiballistic missile may use an appropriate launch method (i.e. chemical rocket, electromagnetic launch with chemical maneuvering rockets). The electromagnetic launch may cost a great deal up front; but, it has the capacity to rapidly launch vast quantities of low cost multiwavelength antiballistic missiles. This may provide multiple opportunities to destroy an enemy missile. The electromagnetic launcher may also boost space hardware. Anything launched electromagnetically will have to be designed to endure high acceleration forces, high temperatures and high electromagnetic fields. Each multiwavelength antiballistic missile may deploy a series of smaller similarly configured missiles for taking on multiple enemy missiles. A larger boost rocket may launch multiple standard size (or various size) multiwavelength antiballistic missiles at the same time.

Several light generating methods may be available on an individual illumination satellite. One or more of the light generating methods may be employed simultaneously by the same illumination satellite. The illumination satellites may serve to improve system tracking performance during both the day and night. The illumination satellite may bathe the enemy missile in ultraviolet/visible/infrared/any wavelength light. The light may illuminate a very small area to a very large area. The intensity of the light may vary from zero to very intense (i.e. laser). Even if a laser does not destroy the enemy missile, it may become a highly luminous target. Multiple illuminating satellites may target one enemy missile (i.e. visible light for viewing, laser light for illuminating/destroying) or may work cooperatively in locating an enemy missile. Accurate tracking ability of multiwavelength or illumination satellites is a function of the satellites ability to position itself in real time. The two main methods of positioning satellites are thrusters and reaction wheels. The thrusters may be designed to emit from zero to maximum thrust in exceptionally tiny increments. The lifetime of the thruster satellite is limited by the fuel supply. The remnants from the burned fuel may be appropriately expelled to minimize distortion of the image and to minimize interference with the illumination beam. The vibration resulting from nozzle thrust may be minimized by design. A reaction wheel satellite may be designed with one or more sets of axes. Each axis may control one or more appropriately specified reaction wheels. By selecting an appropriate range of inertia/mass values for the wheels, very fast to extremely slow and precise movements may be accomplished by the satellite. The reaction wheel may be powered by solar panels with an energy storage system. Such a reaction wheel satellite coupled with a guide star track/handoff, a gyroscope/accelerometer, interferometer based encoders, torque sensors, sinusoidally driven zero cog precision motors, high quality ball bearing/magnetic bearing system and an excellent control algorithm may provide the greatest degree of tracking stability. These same design principles may be applied to the thruster satellite. The vibration from satellite components (i.e. cooling system, pumps, motors, temperature difference) may be minimized by design or turned off during critical periods. It is this type of accuracy that is necessary to enable the satellites to maintain an unshakable lock on the enemy missile. All multiwavelength satellites, illumination satellites and multiwavelength antiballistic missiles must be thoroughly protected from both nuclear/cosmic radiation and nuclear electromagnetic pulses.

A cooling system may be established for any laser system components that are exposed to the intense laser radiation (i.e. laser crystal, laser mirrors, lenses, filters, optics, or any components). An arbitrary pattern of channels may be placed in all heat stressed materials through which may be pumped a cooling medium. Only a small fraction of the laser light that passes through the material passes through the cooling medium. Thus there is minimal interaction with the laser beam. To provide effective cooling the medium does not absorb the laser light. The cooling medium may be pumped to an effective radiator to dispose of the excess heat. Different mediums may be used for the same piece of material. The cooling mediums may be chosen to actively modulate the beam under certain conditions.

I claim:

1.) An antiballistic missile system based on multiwavelength satellites, illuminating satellites and multiwavelength antiballistic missiles may overcome enemy missile countermeasures (i.e. decoys, aerosols, changing trajectory) and destroy the missiles.

2.) Referring to claim 1, the multiwavelength antiballistic missile may be guided by the multiwavelength satellites, the global positioning system, the internal sensory system and the internal navigation system.

3.) Referring to claim 1, the multiwavelength satellite and the multiwavelength antiballistic missile may consist of a main reflector capable of collimating/focusing a wide range of arbitrary wavelengths (i.e. multilayered dielectric reflector) which may be directed to a particular wavelength sensor by appropriate means (i.e. moveable dielectric mirror, moveable filters).

4.) Referring to claim 1, the multiwavelength satellite and the multiwavelength antiballistic missile may view the enemy missile through time division observation permitting condition based wavelength selection/fusion which may provide for more accurate tracking.

5.) Referring to claim 1, closing range target destruction may be based on lidar and internal sensor systems.

6.) Referring to claim 1, a sufficient number of multiwavelength satellites may be deployed to observe and track the enemy missile against the blackness of space thus providing a high resolution view of the missile/countermeasures.

7.) Referring to claim 1, the system on a large scale works roughly as follows:
the multiwavelength satellites may detect and verify the launch of an enemy missile;
an attempt may be made to destroy the enemy missile by the boost phase system;
if the enemy missile survives, an attempt may be made by the postboost phase system;
illuminating satellites may rotate into position, focusing the light (i.e. sun, leds, lasers) onto the enemy missile highlighting it against the blackness of space;
a weak intensity highlight may produce an increase in visibility of the enemy missile;
a strong intensity highlight may produce a direct heating of the enemy missile (to destroy the target directly or to produce a luminous target);
an attempt is made to destroy the enemy missile by the multiwavelength antiballistic missile;
if the enemy missile survives, an attempt is made by the reentry phase system;
the multiwavelength satellites, the illuminating satellites and the multiwavelength antiballistic missiles may be used in any phase of the enemy missile (boost, postboost, reentry).

8.) Referring to claim 1, countermeasures may be defeated by computer/human analysis of the unique missile trajectory (fixed postboost), wavelength selection to see through the aerosol, behavioral movement of the decoy disguised missile (i.e. missile inside balloon)/decoys (i.e. balloon) under different illumination conditions and rapid trajectory updates to maintain lock on an evasive missile (i.e. trajectory changes postboost).

9.) Referring to claim 1, the multiwavelength antiballistic missile may carry additional weaponry to ensure destruction of the target (i.e. high power explosives, electromagnetic pulse weapon, nuclear weapon).

10.) Referring to claim 1, the multiwavelength antiballistic missile may use an appropriate launch method (i.e. chemical rocket, electromagnetic launch with chemical maneuvering rockets).

11.) Referring to claim 1, each multiwavelength antiballistic missile may deploy a series of smaller similarly configured missiles for taking on multiple enemy missiles.

12.) Referring to claim 1, a larger boost rocket may launch multiple standard size (or various size) multiwavelength antiballistic missiles at the same time.

13.) Referring to claim 1, a series of illuminating satellites with large optical systems may cover the earth to highlight/destroy the enemy missile against the blackness of space.

14.) Referring to claim 1, several light generating methods may be available on an individual illumination satellite.

15.) Referring to claim 1, one or more of the light generating methods may be employed simultaneously by the same illumination satellite.

16.) Referring to claim 1, the illumination satellite may illuminate a very small/large area and the intensity of the light may vary from zero to very intense (i.e. laser).

17.) Referring to claim 1, the illumination satellite may bathe the enemy missile in ultraviolet/visible/infrared/any wavelength light.

18.) Referring to claim 1, multiple illuminating satellites may target one enemy missile (i.e. visible light for viewing, laser light for illuminating/destroying or may work cooperatively in locating an enemy missile.

19.) Referring to claim 1, the accurate tracking ability of multiwavelength and illumination satellites is a function of the satellites ability to position itself in real time which may be accomplished by a thruster satellite whose characteristics may include:
the thrusters may be designed to emit from zero to maximum thrust in exceptionally tiny increments;
the lifetime of the thruster is limited by the fuel supply;
the remnants from the burned fuel may be appropriately expelled to minimize distortion of the image (multiwavelength satellite) and to minimize interference with the illumination beam (illumination satellite);
the vibration from nozzle thrust and other items may be minimized by design;
the thruster satellite may be powered by solar panels with an energy storage system;
a thruster satellite coupled with a guide star track/handoff, a gyroscope/accelometer, interferometer based encoders, torque sensors, sinusoidally driven zero cog precision motors, high quality ball bearing/magnetic bearing system, low vibration and an excellent control algorithm may provide the greatest degree of tracking stability.

20.) Referring to claim 1, the accurate tracking ability of multiwavelength and illumination satellites is a function of the satellites ability to position itself in real time which may be accomplished by a reaction wheel satellite whose characteristics may include:
a reaction wheel satellite may be designed with one or more sets of axes;
each axis may control one or more appropriately specified reaction wheels;
by selecting an appropriate range of inertia/mass values for the wheels, very fast to extremely slow and precise movements may be accomplished by the satellite;
the reaction wheel may be powered by solar panels with an energy storage system;
a reaction wheel satellite coupled with a guide star track/handoff, a gyroscope/accelometer, interferometer based encoders, torque sensors, sinusoidally driven zero cog precision motors, high quality ball bearing/magnetic bearing system, low vibration and an excellent control algorithm may provide the greatest degree of tracking stability.

21.) Referring to claim 1, all multiwavelength satellites, illumination satellites and multiwavelength antiballistic missiles must be thoroughly protected from both nuclear/cosmic radiation and nuclear electromagnetic pulses.
